(19) United States
(12) Patent Application Publication
(10) Pub. No.: US 2023/0031556 A1
(43) Pub. Date: Feb. 2, 2023

(54) AUGMENTED REALITY SYSTEM AND OPERATION METHOD THEREOF

(71) Applicant: Acer Incorporated, New Taipei City (TW)

(72) Inventors: Chih-Wen Huang, New Taipei City (TW); Wen-Cheng Hsu, New Taipei City (TW); Yu Fu, New Taipei City (TW); Chao-Kuang Yang, New Taipei City (TW)

(73) Assignee: Acer Incorporated, New Taipei City (TW)

(21) Appl. No.: 17/832,709

(22) Filed: Jun. 6, 2022

(30) Foreign Application Priority Data
Jul. 29, 2021 (TW) 110127878

(51) Int. Cl. G06T 19/00; G06T 7/11; G06T 7/70; G06F 3/01

(52) U.S. Cl. CPC G06T 19/006; G06T 7/11; G06T 7/70; G06F 3/011; G06T 2207/30204

(57) ABSTRACT

The disclosure provides an augmented reality (AR) system and an operation method thereof. The AR system includes a target device, an AR server, and an AR device. The target device displays a marker. The AR server provides a digital content corresponding to the marker. The AR device captures the target device and the marker to generate a picture. The AR device obtains the digital content from the AR server through a communication network. The AR device tracks the target device in the picture according to the marker for an AR application. During the AR application, the AR device overlays the digital content on the target device in the picture.

### CROSS-REFERENCE TO RELATED APPLICATION

This application claims the priority benefit of Taiwan application serial no. 110127878, filed on Jul. 29, 2021. The entirety of the above-mentioned patent application is hereby incorporated by reference herein and made a part of this specification.

### BACKGROUND

### Technical Field

The disclosure relates to a video system, and more particularly to an augmented reality (AR) system and an operation method thereof.

### Description of Related Art

Various audio-visual streaming services have gained increasing popularity. Common audio-visual streaming services include video conferencing. In a video conference, a user A may show something to a user B far away through a communication network. For example, a mobile phone held by the user A is displaying an interesting digital content (a picture or a three-dimensional digital object), and the user A may want to show this digital content to the user B far away through the video conference. Therefore, the user A uses a video conferencing device to take a picture of this mobile phone. However, due to various environmental factors (such as resolution, color shift, or the like), the user B may not be able to see the content displayed by the mobile phone of the user A clearly.

### SUMMARY

The disclosure provides an augmented reality (AR) system and an operation method thereof for an AR application.

In an embodiment of the disclosure, the AR system includes a target device, an AR server, and an AR device. The target device is configured to display the marker. The AR server is configured to provide a digital content corresponding to the marker. The AR device is configured to capture the target device and the marker to generate a picture. The AR device obtains the digital content from the AR server through a communication network. The AR device tracks the target device in the picture according to the marker for an AR application. In the AR application, the AR device overlays the digital content on the target device in the picture.

In an embodiment of the disclosure, the operation method includes the following steps. A target device displays a marker. An AR server provides a digital content corresponding to the marker. An AR device receives the digital content from the AR server through a communication network. The AR device captures the target device and the marker to generate a picture. The AR device tracks the target device in the picture according to the marker for an AR application. In the AR application, the AR device overlays the digital content on the target device in the picture.

Based on the above, the AR device in the embodiments of the disclosure may capture the marker of the target device to generate the picture for the AR application. The AR server may provide the digital content corresponding to the marker to the AR device. During the AR application, the AR device may overlay the digital content provided by the AR server on the target device in the picture. Since the digital content is not fixedly stored in the AR device, the AR device may present AR effect in a more flexible manner.

In order to make the aforementioned features and advantages of the disclosure comprehensible, embodiments accompanied with drawings are described in detail below.

### BRIEF DESCRIPTION OF THE DRAWINGS

FIG. 1 is a schematic diagram of a circuit block of an augmented reality (AR) system according to an embodiment of the disclosure.

FIG. 2 is a schematic flow chart of an operation method of an AR system according to an embodiment of the disclosure.

FIG. 3 is a schematic diagram of a scenario of an AR application according to an embodiment of the disclosure.

FIG. 4 is a schematic diagram of a circuit block of an AR system according to another embodiment of the disclosure.

FIG. 5 is a schematic diagram of a circuit block of a target device according to an embodiment of the disclosure.

FIG. 6 is a schematic diagram of a circuit block of an AR device according to an embodiment of the disclosure.

### DESCRIPTION OF THE EMBODIMENTS

Throughout the text of the specification (including the claims), the term “couple (or connect)” refers to any direct or indirect connection means. For example, where a first device is described to be coupled (or connected) to a second device in the text, it should be interpreted that the first device may be directly connected to the second device, or that the first device may be indirectly connected to the second device through another device or some connection means. The terms “first,” “second,” and the like mentioned in the specification or the claims are used only to name the elements or to distinguish different embodiments or scopes, and are not intended to limit the upper or lower limit of the number of the elements, nor are they intended to limit the order of the elements. Moreover, wherever applicable, elements/components/steps referenced by the same numerals in the figures and embodiments refer to the same or similar parts. Elements/components/steps referenced by the same numerals or the same language in different embodiments may be mutually referred to for relevant descriptions.

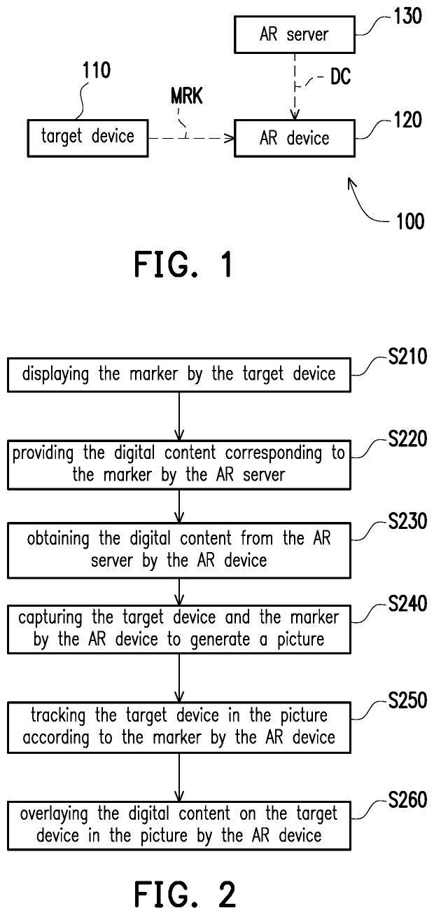

FIG. 1 is a schematic diagram of a circuit block of an augmented reality (AR) system 100 according to an embodiment of the disclosure. The AR system 100 shown in FIG. 1 includes a target device 110, an AR device 120, and an AR server 130. A user may use the AR device 120 to capture the target device 110 to generate a picture. This embodiment does not limit the specific product categories of the AR device 120 and the target device 110. For example, in some embodiments, the target device 110 may include a mobile phone, a smart watch, a tablet computer, or other electronic apparatuses, and the AR device 120 may include a local computer, a head-mounted display, and/or other AR devices.

FIG. 2 is a schematic flow chart of an operation method of an AR system according to an embodiment of the disclosure. With reference to FIG. 1 and FIG. 2, in step 210, the target device 110 may display a marker MRK. Based on the actual design, the marker MRK may include an ArUco marker, a quick response (QR) code, or any predefined geometric figure. The AR device 120 may establish a communication connection with the AR server 130 through a communication network. According to the actual design, the communication network may include Wi-Fi wireless network, Ethernet, the Internet, and/or other communication networks. Therefore, the AR server 130 may provide a digital content DC corresponding to the marker MRK to the AR device 120 (step S220). The digital content DC may be set according to actual applications. For example, in some embodiments, the digital content DC may include a two-dimensional image frame, a three-dimensional digital object, and/or other digital contents. The two-dimensional image frame may include a photo, a video, or other image signal. In step S230, the AR device 120 may obtain the digital content DC from the AR server 130 through the communication network.

In step S240, the AR device 120 may capture the target device 110 and the marker MRK to generate a picture (or a picture stream). The AR device 120 may, for example (but not limited to), obtain digital content download information for the AR server 130 according to the marker MRK displayed by the target device 110. According to the actual design, in some embodiments, the marker MRK may include a QR code or other programmable figure, and the digital content download information may be embedded into the marker MRK. According to the actual design, the digital content download information may include an address of the AR server 130, an identification code of the target device 110, a digital content identification code, and/or other related information of digital content download. The AR device 120 may obtain the digital content DC from the AR server 130 through the communication network according to the digital content download information.

In step S250, the AR device 120 may track the target device 110 in the picture for an AR application. According to the actual design, the AR application may include a game application, an education application, a video conferencing application, and/or other applications. During the AR application, the AR device 120 may overlay the digital content DC provided by the AR server 430 on the target device 110 in the picture (step S260).

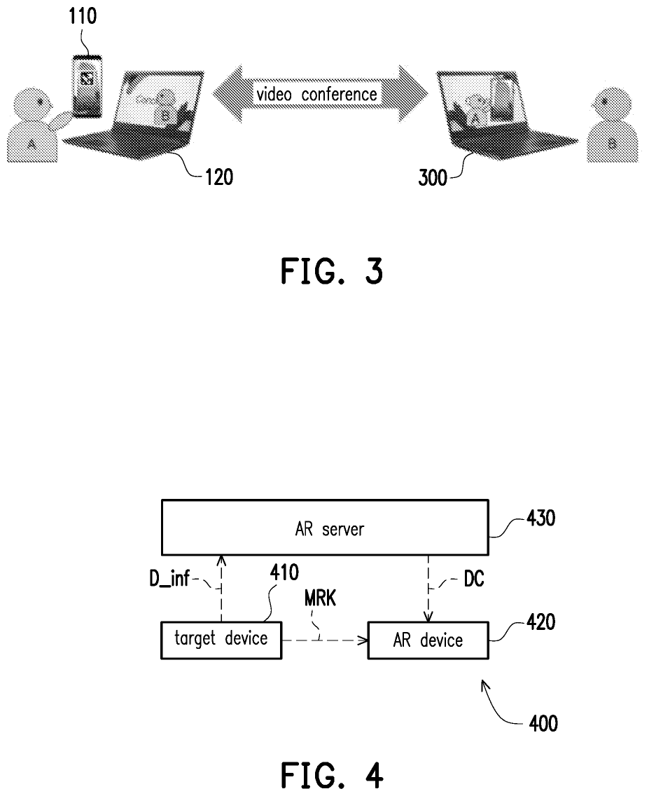

FIG. 3 is a schematic diagram of a scenario of an AR application according to an embodiment of the disclosure. In the embodiment shown by FIG. 3, the AR application may include a video conferencing application. With reference to FIG. 1 and FIG. 3, the AR device 120 may be connected to a remote device 300 through a communication network. According to the actual design, the communication network may include Wi-Fi wireless network, Ethernet, the Internet, and/or other communication networks. In the embodiment shown in FIG. 3, the target device 110 may include a smart phone, and the AR device 120 and the remote device 300 may include notebook computers. The AR device 120 may transmit a picture to the remote device 300 through the communication network for video conferencing.

In the video conference shown by FIG. 3, a user A may show something to a user B far away through the communication network. For example, the target device 110 held by the user A is displaying an interesting digital content (a picture or a three-dimensional digital object), and the user A may want to show this digital content to the user B far away through the video conference. Therefore, the user A uses the AR device 120 to capture the picture displayed by the target device 110. However, due to various environmental factors (such as resolution, color shift, or the like), the user B may not be able to clearly see the content captured by the AR device 120 and displayed by the target device 110.

Therefore, in the video conference (AR application), the target device 110 may provide the digital content DC being displayed to the AR device 120, and the AR device 120 may capture the target device 110 and the user A to generate a picture (here referred to as a conference picture). The AR device 120 may overlay the digital content DC on the target device 110 in the conference picture to generate an AR conference picture. The AR device 120 may transmit the AR conference picture to the remote device 300 through the communication network for video conferencing. The remote device 300 may display the AR conference picture to the user B. Since the digital content being displayed by the target device 110 that the user B sees is not captured by the AR device 120, the digital content does not have issues such as resolution or color shift.

For example, based on the actual design, the digital content provided by the target device 110 to the AR device 120 may include a three-dimensional digital object, and the target device 110 has at least one attitude sensor (not shown in FIG. 1 and FIG. 3) to detect an attitude of the target device 110. For example, the attitude sensor may include an acceleration sensor, a gravity sensor, a gyroscope, an electronic compass, and/or other sensors. The target device 110 may provide attitude information corresponding to the attitude of the target device 110 to the AR device 120 through a communication connection. According to actual design, the communication connection may include Bluetooth, Wi-Fi wireless network, universal serial bus (USB), and/or other communication connection interfaces. The AR device 120 may capture the target device 110 to generate a picture (for example, a meeting picture) and overlay a three-dimensional digital object (the digital content DC) on the target device 110 in the picture. The AR device 120 may adjust the attitude of the three-dimensional digital object in the picture in correspondence to the attitude information of the target device 110.

FIG. 4 is a schematic diagram of a circuit block of an AR system 400 according to another embodiment of the disclosure. The AR system 400 shown in FIG. 4 includes a target device 410, an AR device 420, and an AR server 430. The target device 410, the AR device 420, and the AR server 430 shown in FIG. 4 may be inferred by analogy with reference to relevant description of the target device 110, the AR device 120, and the AR server 130 shown in FIG. 1, and details thereof are not described herein.

In the embodiment shown in FIG. 4, the target device 410 may provide display information D_inf to the AR server 430 through a communication network. According to the actual design, the communication network may include Wi-Fi wireless network, Ethernet, the Internet, and/or other communication networks. The AR server 430 may convert the display information D_inf into the digital content DC for providing the digital content DC to the AR device 420. According to the actual design, in some embodiments, the display information D_inf may include a device identification code corresponding to the target device 410. In some other embodiments, the display information D_inf may include a display content currently displayed corresponding to the target device 410.

It is assumed herein that the display information D_inf may include the device identification code corresponding to the target device 410. The target device 410 may display the marker MRK for transmitting the device identification code of the target device 410 to the AR device 420. The AR device 420 may transmit a content request carrying the device identification code to the AR server 430 through the communication network, and the target device 410 may provide the display information D_inf carrying the device identification code to the AR server 430 through the communication network. The AR server 430 may compare the device identification code of the display information D_inf with the device identification code of the content request of the AR device 420 to generate a comparison result. The AR server 430 may determine whether to provide the digital content DC to the AR device 420 according to the comparison result.

It is assumed herein that the display information D_inf may include the display content currently displayed corresponding to the target device 410. The AR server 430 may perform a value-added service for converting the display content (the display information D_inf) currently displayed by the target device 410 into the digital content DC. The value-added service may be different according to the actual design/application. For example, in some embodiments, the value-added service provided by the AR server 430 may include a super-resolution (SR) imaging service, a three-dimensional image conversion service, an image enhancement service, a translation service, and/or other services. The “super-resolution imaging” is a technique improving video resolution. The super-resolution imaging service provided by the AR server 430 may enhance the display content (the display information D_inf) currently displayed by the target device 410 as the digital content DC. The three-dimensional image conversion service provided by the AR server 430 may convert a two-dimensional display content (the display information D_inf) currently displayed by the target device 410 into a three-dimensional content as the digital content DC. The image enhancement service provided by the AR server 430 includes performing a de-blurring operation on the display content (the display information D_inf) currently displayed by the target device 410 for converting the display content (the display information D_inf) into the digital content DC. The translation service provided by the AR server 430 may convert a text content (the display information D_inf) currently displayed by the target device 410 from a first language into a second language and use a conversion result as the digital content DC.

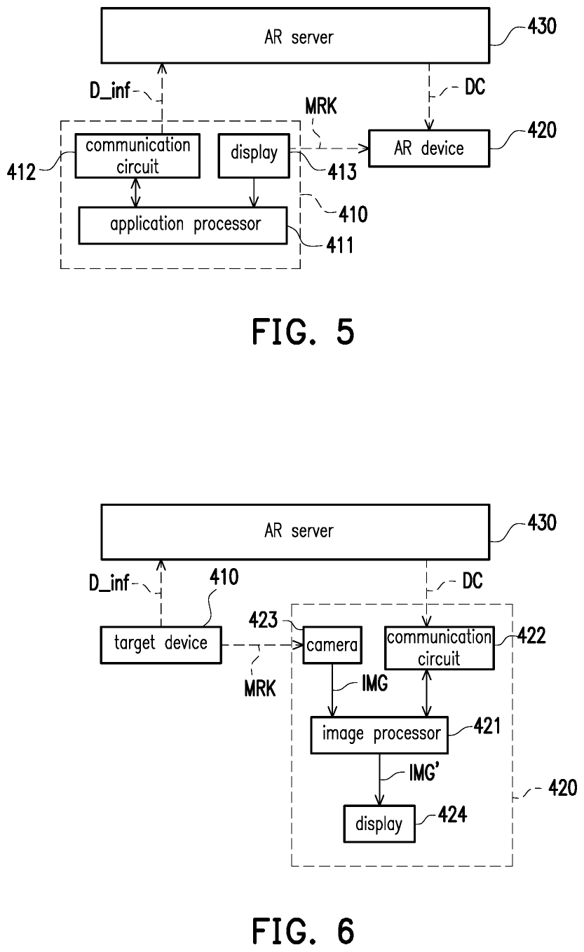

FIG. 5 is a schematic diagram of a circuit block of a target device 410 according to an embodiment of the disclosure. According to the actual design, in some embodiments, the target device 110 shown in FIG. 1 may be inferred by analogy with reference to relevant description of the target device 410 shown in FIG. 5. In the embodiment shown by FIG. 5, the target device 410 includes an application processor 411, a communication circuit 412, and a display 413. With reference to FIG. 4 and FIG. 5, the application processor 411 is coupled to the communication circuit 412 and the display 413. The communication circuit 412 may establish a connection with the AR server 430 for providing the display information D_inf to the AR server 430. Based on the driving and control of the application processor 411, the display 413 may display the marker MRK. The AR device 420 may capture the marker MRK displayed by the display 413 to locate the target device 410 in the picture.

FIG. 6 is a schematic diagram of a circuit block of an AR device 420 according to an embodiment of the disclosure. According to the actual design, in some embodiments, the AR device 120 shown in FIG. 1 may be inferred by analogy with reference to relevant description of the AR device 420 shown in FIG. 6. In the embodiment shown by FIG. 6, the AR device 420 includes an image processor 421, a communication circuit 422, a camera 423, and a display 424. The image processor 421 is coupled to the communication circuit 422, the camera 423, and the display 424. The communication circuit 422 may establish a connection with the AR server 430 to receive the digital content DC. The camera 423 may capture the target device 410 and the marker MRK to generate a picture IMG. The image processor 421 may locate the target device 410 in the picture IMG according to the marker MRK displayed by the target device 410. The image processor 421 may overlay the digital content DC on the target device 410 in the picture IMG to generate a picture IMG′ that is overlaid. The display 424 is coupled to the image processor 421 to receive the picture IMG′. Based on the driving and control of the image processor 421, the display 424 may display the image IMG′ overlaid with the digital content DC.

According to different design requirements, the application processor 411 and/or the image processor 421 may be implemented as a hardware, a firmware, a software (i.e., a program), or a combination of many among the above three. In terms of hardware, the application processor 411 and/or the image processor 421 may be implemented at a logic circuit on an integrated circuit. Related functions of the application processor 411 and/or the image processor 421 may be implemented as a hardware by using hardware description languages such as Verilog, HDL, or VHDL, or other suitable programming languages. For example, the related functions of the application processor 411 and/or the image processor 421 may be implemented at various logic blocks, modules and circuits in one or more controllers, microcontrollers, microprocessors, application-specific integrated circuits (ASIC), digital signal processors (DSP), field programmable gate arrays (FPGA), and/or other processing units.

In terms of software and/or firmware, the related functions of the application processor 411 and/or the image processor 421 may be implemented as programming codes. For example, general programming languages (such as C, C++, or assembly languages) or other suitable programming languages are used to implement the application processor 411 and/or image processor 421. The programming codes may be recorded/stored in a non-transitory computer readable medium. In some embodiments, the non-transitory computer readable medium includes, for example, a read only memory (ROM), a tape, a disk, a card, a semiconductor memory, a programmable logic circuit and/or a memory device. The memory device includes a hard disk drive (HDD), a solid-state drive (SSD), or other memory device. A computer, a central processing unit (CPU), a controller, a microcontroller, or a microprocessor may read and execute the programming codes from the non-transitory computer readable medium, thereby implementing the related functions of the application processor 411 and/or the image processor 421. Moreover, the programming codes may also be provided to the computer (or the CPU) through any transmission medium (a communication network, a broadcast wave, or the like). The communication network is, for example, the Internet, a wired communication network, a wireless communication network, or other communication medium.

In summary, the AR device of the embodiments above may capture the marker of the target device 110 to generate the picture for the AR application. The AR server may provide the digital content corresponding to the marker MRK to the AR device. During the AR application, the AR device may overlay the digital content provided by the AR server on the target device in the picture. Since the digital content is not fixedly stored in the AR device, the AR device may present AR effect in a more flexible manner.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. An augmented reality system, comprising:
a target device, configured to display a marker,
an augmented reality server, configured to provide a digital content corresponding to the marker; and
an augmented reality device, configured to capture the target device and the marker to generate a picture, wherein the augmented reality device obtains the digital content from the augmented reality server through a communication network, the augmented reality device tracks the target device in the picture according to the marker for an augmented reality application, and the augmented reality device overlays the digital content on the target device in the picture in the augmented reality application.

2. The augmented reality system according to claim 1, wherein the marker comprises an ArUco marker.

3. The augmented reality system according to claim 1, wherein the augmented reality device further obtains digital content download information for the augmented reality server according to the marker, and the augmented reality device obtains the digital content from the augmented reality server through the communication network according to the digital content download information.

4. The augmented reality system according to claim 1, wherein the target device provides display information to the augmented reality server through the communication network, and the augmented reality server converts the display information into the digital content for providing the digital content to the augmented reality device.

5. The augmented reality system according to claim 4, wherein the display information comprises a device identification code corresponding to the target device, the target device transmits the device identification code to the augmented reality device by displaying the marker, the augmented reality device transmits a content request carrying the device identification code to the augmented reality server through the communication network, the augmented reality server compares the device identification code of the display information with the device identification code of the content request to generate a comparison result, and the augmented reality server determines whether to provide the digital content to the augmented reality device according to the comparison result.

6. The augmented reality system according to claim 4, wherein the display information comprises a display content currently displayed corresponding to the target device, and the augmented reality server performs a value-added service to convert the display content into the digital content.

7. The augmented reality system according to claim 6, wherein the value-added service comprises at least one of a super-resolution imaging service, a three-dimensional image conversion service, an image enhancement service, and a translation service.

8. The augmented reality system according to claim 7, wherein the image enhancement service comprises performing a de-blurring operation on the display content for converting the display content into the digital content.

9. The augmented reality system according to claim 1, wherein the digital content comprises a three-dimensional digital object, the target device has at least one attitude sensor for detecting an attitude of the target device, the target device provides attitude information corresponding to the attitude of the target device to the augmented reality device, and the augmented reality device correspondingly adjusts an attitude of the three-dimensional digital object in the picture based on the attitude information.

10. The augmented reality system according to claim 1, wherein the augmented reality device transmits the picture to a remote device through the communication network for a video conference in the augmented reality application.

11. The augmented reality system according to claim 1, wherein the target device comprises:
a display, configured to display the marker; and
a communication circuit, configured to establish a connection with the augmented reality server for providing display information to the augmented reality server.

12. The augmented reality system according to claim 1, wherein the augmented reality device comprises:
a communication circuit, configured to establish a connection with the augmented reality server for receiving the digital content;
a camera, configured to capture the target device and the marker to generate the picture; and
an image processor, coupled to the communication circuit and the camera, wherein the image processor locates the target device in the picture according to the marker, and the image processor overlays the digital content on the target device in the picture.

13. The augmented reality system according to claim 12, wherein the augmented reality device further comprises:
a display, coupled to the image processor and configured to display the picture overlaid with the digital content.

14. The augmented reality system according to claim 1, wherein the target device comprises a mobile phone, and the augmented reality device comprises a local computer.

15. An operation method of an augmented reality system, comprising:
displaying a marker by a target device;
providing a digital content corresponding to the marker by an augmented reality server;
obtaining the digital content from the augmented reality server through a communication network by an augmented reality device;
capturing the target device and the marker by the augmented reality device to generate a picture;
tracking the target device in the picture according to the marker by the augmented reality device for an augmented reality application; and
overlaying the digital content on the target device in the picture by the augmented reality device in the augmented reality application.

16. The operation method according to claim 15, wherein the marker comprises an ArUco marker.

17. The operation method according to claim 15, further comprising:
obtaining digital content download information for the augmented reality server according to the marker by the augmented reality device; and
obtaining the digital content from the augmented reality server through the communication network according to the digital content download information by the augmented reality device.

18. The operation method according to claim 15, further comprising:
providing display information to the augmented reality server through the communication network by the target device; and
converting the display information into the digital content for providing the digital content to the augmented reality device by the augmented reality server.

19. The operation method according to claim 18, wherein the display information comprises a device identification code corresponding to the target device, and the operation method further comprises:
transmitting the device identification code to the augmented reality device by displaying the marker by the target device;
transmitting a content request carrying the device identification code to the augmented reality server through the communication network by the augmented reality device;
comparing the device identification code of the display information with the device identification code of the content request to generate a comparison result by the augmented reality server; and
determining whether to provide the digital content to the augmented reality device according to the comparison result by the augmented reality server.

20. The operation method according to claim 18, wherein the display information comprises a display content currently displayed corresponding to the target device, and the operation method further comprises:
performing a value-added service by the augmented reality server for converting the displayed content into the digital content.

21. The operation method according to claim 20, wherein the value-added service comprises at least one of a super-resolution imaging service, a three-dimensional image conversion service, an image enhancement service, and a translation service.

22. The operation method according to claim 21, wherein the image enhancement service comprises performing a de-blurring operation on the display content for converting the display content into the digital content.

23. The operation method according to claim 15, wherein the digital content comprises a three-dimensional digital object, and the operation method further comprises:
detecting an attitude of the target device by at least one attitude sensor of the target device;
providing attitude information corresponding to the attitude of the target device to the augmented reality device by the target device; and
correspondingly adjusting an attitude of the three-dimensional digital object in the picture based on the attitude information by the augmented reality device.

24. The operation method according to claim 15, further comprising:
transmitting the picture to a remote device through the communication network for a video conference by the augmented reality device in the augmented reality application.

25. The operation method according to claim 15, wherein the target device comprises a mobile phone, and the augmented reality device comprises a local computer.
